(19) United States
(12) Patent Application Publication
(10) Pub. No.: US 2025/0119063 A1
(43) Pub. Date: Apr. 10, 2025

(54) MULTI-LEVEL DIRECT CURRENT CONVERTER, VOLTAGE CONTROL METHOD FOR FLYING CAPACITOR, AND CONTROL APPARATUS

(71) Applicant: Huawei Digital Power Technologies Co., Ltd., Shenzhen (CN)

(72) Inventors: Rong Wu, Shenzhen (CN); Shaohui Zhong, Shenzhen (CN); Zhiqing Wu, Shenzhen (CN); Jing Zhao, Xi’an (CN); Juntao Fan, Xi’an (CN)

(73) Assignee: Huawei Digital Power Technologies Co., Ltd., Shenzhen (CN)

(21) Appl. No.: 18/990,969

(22) Filed: Dec. 20, 2024

Related U.S. Application Data
(63) Continuation of application No. PCT/CN2023/098923, filed on Jun. 7, 2023.

(30) Foreign Application Priority Data
Jun. 23, 2022 (CN) 202210715575.6

(51) Int. Cl. H02M 3/158; H02M 1/00; H02M 1/32; H02M 3/07

(52) U.S. Cl. CPC H02M 3/1586; H02M 1/0095; H02M 1/32; H02M 3/07

(57) ABSTRACT

A multi-level direct current converter, a voltage control method for a flying capacitor, and a control apparatus are provided. The multi-level direct current converter includes a controller, a flying capacitor, two switching transistor groups, and an inductor. The method for controlling a flying capacitor includes: in response to that an absolute value of a difference between a sampling voltage and a reference voltage of the flying capacitor is greater than a first threshold, adjusting a duty cycle difference between first switching transistors in two switching transistor groups or a phase difference between carriers of first switching transistors in two switching transistor groups based on a magnitude of an inductor current. According to this application, a voltage of the flying capacitor can be controlled, to improve operation stability of the multi-level direct current converter.

### CROSS-REFERENCE TO RELATED APPLICATIONS

This application is a continuation of International Application No. PCT/CN2023/098923, filed on Jun. 7, 2023, which claims priority to Chinese Patent Application No. 202210715575.6, filed on Jun. 23, 2022. The disclosures of the aforementioned applications are hereby incorporated by reference in their entireties.

### TECHNICAL FIELD

Embodiments of this application relate to the field of power electronics technologies, and in particular, to a multi-level direct current converter, a voltage control method for a flying capacitor, and a control apparatus.

### BACKGROUND

A multi-level direct current converter can reduce a voltage stress of an input voltage on each switching transistor by adding a flying capacitor. A three-level direct current converter with the flying capacitor is used as an example, and a half of an input voltage may be stored by using a flying voltage, so that an output level has three states: 0, ½, and 1, and a change amplitude of the output levels is half of a two-level topology. In this way, a switching transistor with a low withstand voltage may be used to improve performance of an electronic system.

Currently, charge/discharge time of the flying capacitor may be adjusted by determining a current direction of an inductor and adjusting a difference between duty cycles of first switching transistors (or second switching transistors) in a switching transistor group, to control a voltage of the flying capacitor. However, when an inductor current is small, and the inductor current is a high-frequency triangular wave, and is repeatedly switched between positive and negative, controlling the voltage of the flying capacitor based on an instantaneous current direction has an extremely high requirement on a control chip, and is not applicable to an actual project. Even if the difference between the duty cycles of the first switching transistors (or the second switching transistors) in the switching transistor group is adjusted to a large value, the flying voltage cannot be effectively increased or decreased, and a control objective of stabilizing the voltage of the flying capacitor at a target value cannot be achieved.

### SUMMARY

Embodiments of this application provide a multi-level direct current converter, a voltage control method for a flying capacitor, and a control apparatus, to control a voltage of the flying capacitor. This improves operation stability of the multi-level direct current converter.

According to a first aspect, an embodiment of this application provides a multi-level direct current converter. The multi-level direct current converter includes at least one flying capacitor, two switching transistor groups connected to the flying capacitor, an inductor connected to each switching transistor group and a positive electrode end of a low-voltage power supply of the multi-level direct current converter, and a controller configured to control the switching transistor groups, where each switching transistor group includes a first switching transistor and a second switching transistor which on and off states are complementary, the first switching transistor is connected to one end of a high-voltage power supply of the multi-level direct current converter, and the second switching transistor is connected to the other end of the high-voltage power supply of the multi-level direct current converter; and the controller is configured to: when an absolute value of a difference between a sampling voltage and a reference voltage of the flying capacitor is greater than a first threshold, adjust a duty cycle difference between first switching transistors in the two switching transistor groups or a phase difference between carriers of first switching transistors in the two switching transistor groups based on a magnitude of an inductor current.

The multi-level direct current converter, is configured to perform direct current (DC)-direct current electric energy conversion, for example, may perform boost conversion, or may perform buck conversion. A specific type of the multi-level direct current converter is not limited in this application, and may be a three-level direct current converter, a five-level direct current converter, a seven-level direct current converter, or the like. A multi-level topology corresponding to the multi-level direct current converter means that an output level has at least three states. For example, the output level has three states: 1, ½, and 0, which is referred to as the three-level topology. The output level has five states: 1, ¾, ½, ¼, and 0, which is referred to as the five-level topology.

The first switching transistor and the second switching transistor may be field effect transistors (FET), metal oxide semiconductor field effect transistors (MOSFET), insulated gate bipolar transistors (IGBT), junction field effect transistors (JFET), parallel diodes thereof, and the like. This is not limited herein.

The controller may be a pulse width modulation (PWM) device, a PWM-based battery management system (BMS), a micro control unit (MCU), a central processing unit (CPU), another general purpose processor, a digital signal processor (DSP), an application specific integrated circuit (ASIC), a field-programmable gate array (FPGA) or another programmable logic device, a discrete gate or transistor logic device, a discrete hardware component, or the like. The controller may be one chip or a plurality of chips that have a communication connection. The controller may include a control unit corresponding to each switching transistor, or may include a control unit corresponding to a switching transistor group, for example, a pulse width modulator corresponding to a first switching transistor and a second switching transistor in the switching transistor group. This is not limited herein.

The sampling voltage of the flying capacitor is a collected real-time voltage. The reference voltage of the flying capacitor is a target value to be adjusted for the flying capacitor. A current of an inductor is also referred to as the inductor current, and may be an instantaneous current value or an average value.

The first threshold is not limited in this application. The first threshold may be 0, or the like. It may be understood that, if the absolute value of the difference between the sampling voltage and the reference voltage of the flying capacitor is greater than the first threshold, it indicates that a voltage of the flying capacitor is not adjusted to a target value (for example, the target value of the three-level direct current converter may be ½ times a voltage of the high-voltage power supply). A duty cycle difference between switching transistors on a side of the flying capacitor or a phase difference between carriers of first switching transistors on the side may continue to be adjusted, to control the voltage of the flying capacitor and reduce a voltage stress of the multi-level direct current converter. If the difference between the sampling voltage and the reference voltage of the flying capacitor is less than or equal to the first threshold, it indicates that the voltage of the flying capacitor has been adjusted to the target value, and a current operating state may be maintained and the flying capacitor continues to operate. In this way, operation stability of the multi-level direct current converter can be improved.

With reference to the first aspect, in a first possible implementation, the controller is specifically configured to increase the phase difference between the carriers of the first switching transistors in the two switching transistor groups when the controller determines to adjust the phase difference between the carriers of the first switching transistors in the two switching transistor groups based on the magnitude of the inductor current, and the sampling voltage of the flying capacitor is less than the reference voltage of the flying capacitor. In this way, the voltage of the flying capacitor can be increased.

With reference to the first aspect, in a second possible implementation, the controller is specifically configured to decrease the phase difference between the carriers of the first switching transistors in the two switching transistor groups when the controller determines to adjust the phase difference between the carriers of the first switching transistors in the two switching transistor groups based on the magnitude of the inductor current, and the sampling voltage of the flying capacitor is greater than the reference voltage of the flying capacitor. In this way, the voltage of the flying capacitor can be reduced.

With reference to the first aspect, or the first possible implementation, or the second possible implementation, in a third possible implementation, the controller is specifically configured to adjust the phase difference between the carriers of the first switching transistors in the two switching transistor groups when the inductor current is less than a second threshold.

With reference to the first aspect, in a fourth possible implementation, the controller is specifically configured to adjust the duty cycle difference between the first switching transistors in the two switching transistor groups when the inductor current is greater than a third threshold.

With reference to the first aspect, or the first possible implementation, or the second possible implementation, in a fifth possible implementation, the controller is specifically configured to: when the inductor current is greater than or equal to a second threshold and less than or equal to a third threshold, adjust, according to an adjustment method at a previous moment, the duty cycle difference between the first switching transistors in the two switching transistor groups or the phase difference between the carriers of the first switching transistors in the two switching transistor groups.

Values of the second threshold and the third threshold are not limited in this application, and the second threshold is less than the third threshold. It may be understood that, if the current of the inductor is less than the second threshold, it indicates that the current of the inductor is small, and the current may be a case of light load. On the premise that the duty cycle difference is not adjusted, the phase difference between the carriers of the first switching transistors in the two switching transistor groups may be adjusted by using a phase shift control method. If the current of the inductor is greater than the third threshold, it indicates that the current of the inductor is large, and the current may be a heavy load case. On the premise that the phase difference is not adjusted, the duty cycle difference between the first switching transistors in the two switching transistor groups may be adjusted by using a duty cycle adjustment method. If the current of the inductor is greater than or equal to the second threshold and less than or equal to the third threshold, the inductor may be in an intermediate state of light load and heavy load, and the adjustment may be performed in an adjustment manner at a previous moment. For example, if the phase shift control method is used at the previous moment, the phase shift control method is still used; or if the duty cycle adjustment method is used at the previous moment, the duty cycle adjustment method is still used. In this way, a flying voltage may be controlled by using the foregoing three cases, so that the voltage of the controlled flying capacitor keeps smooth transition.

According to a second aspect, an embodiment of this application provides a voltage control method for a flying capacitor. The flying capacitor is used in a multi-level direct current converter, the multi-level direct current converter further includes two switching transistor groups, an inductor, and a controller, and each switching transistor group includes a first switching transistor and a second switching transistor which on and off states are complementary; and the voltage control method includes: when an absolute value of a difference between a sampling voltage and a reference voltage of the flying capacitor is greater than a first threshold, adjusting, based on a magnitude of the inductor current, a duty cycle difference between first switching transistors in the two switching transistor groups or a phase difference between carriers of first switching transistors in the two switching transistor groups. In this way, when it is determined that the voltage of the flying capacitor is not adjusted to the target value, a duty cycle difference between switching transistors on a side of the flying capacitor or a phase difference between carriers of switching transistors on the side of the flying capacitor may continue to be adjusted, to control the voltage of the flying capacitor. This improves operation stability of the multi-level direct current converter.

With reference to the second aspect, in a first possible implementation, the adjusting, based on a magnitude of the inductor current, a duty cycle difference between first switching transistors in the two switching transistor groups or a phase difference between carriers of first switching transistors in the two switching transistor groups includes: increasing the phase difference between the carriers of the first switching transistors in the two switching transistor groups when the phase difference between the carriers of the first switching transistors in the two switching transistor groups is determined to be adjusted based on the magnitude of the inductor current, and the sampling voltage of the flying capacitor is less than the reference voltage of the flying capacitor.

With reference to the second aspect, in a second possible implementation, the adjusting, based on a magnitude of the inductor current, a duty cycle difference between first switching transistors in the two switching transistor groups or a phase difference between carriers of first switching transistors in the two switching transistor groups includes: decreasing the phase difference between the carriers of the first switching transistors in the two switching transistor groups when the phase difference between the carriers of the first switching transistors in the two switching transistor groups is determined to be adjusted based on the magnitude of the inductor current, and the sampling voltage of the flying capacitor is greater than the reference voltage of the flying capacitor.

With reference to the second aspect, in a third possible implementation, the adjusting, based on a magnitude of the inductor current, a duty cycle difference between first switching transistors in the two switching transistor groups or a phase difference between carriers of first switching transistors in the two switching transistor groups includes: adjusting, by the controller, the phase difference between the carriers of the first switching transistors in the two switching transistor groups when the inductor current is less than a second threshold.

With reference to the second aspect, in a fourth possible implementation, the adjusting, by the controller based on a magnitude of the current, a duty cycle difference between first switching transistors in the two switching transistor groups or a phase difference between carriers of first switching transistors in the two switching transistor groups includes: in response to that the current is greater than a third threshold, adjusting, by the controller, the duty cycle difference between the first switching transistors in the two switching transistor groups.

With reference to the second aspect, in a fifth possible implementation, the adjusting, by the controller based on a magnitude of the current, a duty cycle difference between first switching transistors in the two switching transistor groups or a phase difference between carriers of first switching transistors in the two switching transistor groups includes: in response to that the current is greater than or equal to the second threshold and less than or equal to the third threshold, adjusting, by the controller according to an adjustment method at a previous moment, the duty cycle difference between the first switching transistors in the two switching transistor groups or the phase difference between the carriers of the first switching transistors in the two switching transistor groups.

According to a third aspect, an embodiment of this application provides a control apparatus. The control apparatus includes a controller and a memory. The memory is configured to store instructions, and the controller is configured to invoke the instructions stored in the memory, to perform the method in the second aspect.

It should be understood that, for implementations and beneficial effects of the foregoing aspects of this application, reference may be made to each other.

### BRIEF DESCRIPTION OF DRAWINGS

The following describes the accompanying drawings used in embodiments of this application.

FIG. 1 is a schematic diagram of an architecture of a photovoltaic power generation system according to an embodiment of this application;

FIG. 2 is a circuit diagram of a three-level direct current converter according to an embodiment of this application;

FIG. 3 is a schematic diagram of a structure of a multi-level direct current converter according to an embodiment of this application;

FIG. 4 to FIG. 9 are operating mode diagrams of a three-level direct current converter according to this application;

FIG. 10 to FIG. 13 are diagrams of a relationship between a duty cycle difference and a flying voltage and a relationship between a phase difference and a flying voltage according to this application;

FIG. 14 is a schematic flowchart of adjusting a voltage of a flying capacitor by a controller according to an embodiment of this application; and

FIG. 15 is a schematic flowchart of a voltage control method for a flying capacitor according to an embodiment of this application.

### DESCRIPTION OF EMBODIMENTS

A “connection” described in this application is a direct or indirect connection. For example, that A is connected to B may be that A is directly connected to B, or may be that A is indirectly connected to B through one or more other electrical components. For example, A may be directly connected to C, and C may be directly connected to B, so that A and B are connected by using C. The connection may alternatively be referred to as a coupling, an electrical connection, or the like. This is not limited herein. Terms “first” and “second” are merely used for a purpose of description, and shall not be understood as an indication or implication of relative importance.

Embodiments of this application relate to a multi-level direct current converter, and is configured to perform direct current (DC)-direct current electric energy conversion, for example, may perform boost conversion, or may perform buck conversion. This is not specifically limited in embodiments of this application. In addition, an application scenario of the multi-level direct current converter is not limited in embodiments of this application. The multi-level direct current converter may be used in different types of electric devices (such as a power grid, a home device, or an industrial and commercial electric device), may be used in different application scenarios such as an electric device field such as a user terminal (such as a mobile phone, an intelligent device, or a television set) field and a vehicle field, and may be used in a power supply scenario of a large electric device (such as a power grid and an industrial device) and a power supply scenario of a small and medium-sized distributed electric device (such as a vehicle-mounted electric device and a home electric device), and a power supply scenario of a mobile electric device (such as a mobile phone and an intelligent device), and the like.

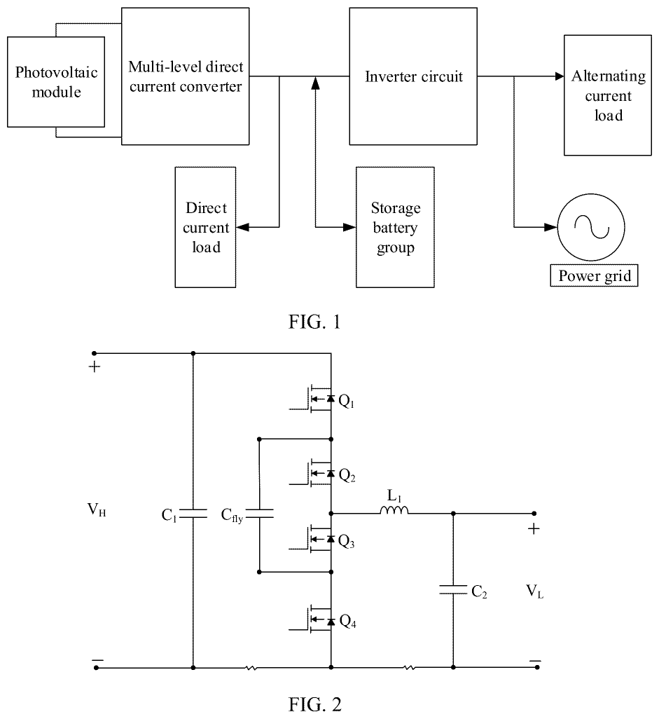

For example, FIG. 1 is a schematic diagram of an architecture of a photovoltaic power generation system according to an embodiment of this application. As shown in FIG. 1, the photovoltaic power generation system includes a photovoltaic module, a multi-level direct current converter, a storage battery group, an inverter circuit, direct current load, alternating current load, and a power grid. In the photovoltaic power generation system, solar energy is converted into direct current energy by the photovoltaic module. The direct current energy is boosted by using the multi-level direct current converter. The boosted direct current energy may be supplied to the direct current load, or may be stored in the storage battery group, or may be converted into alternating current energy by using an inverter, so that the alternating current energy can be supplied to the alternating current load or connected to the power grid.

A specific type of the multi-level direct current converter is not limited in this application, and may be a three-level direct current converter, a five-level direct current converter, a seven-level direct current converter, or the like. A multi-level topology corresponding to the multi-level direct current converter means that an output level has at least three states. For example, the output level has three states: 1, ½, and 0, which is referred to as a three-level topology. The output level has five states: 1, ¾, ½, ¼, and 0, which is referred to as a five-level topology. In addition, multi-level topology circuits are further classified into a diode-clamped multi-level topology circuit, a flying capacitor-clamped multi-level topology circuit, and other forms. The topology circuit of the multi-level direct current converter in this application may be the flying capacitor-clamped multi-level topology circuit, which includes a flying capacitor.

To make a person skilled in the art better understand the technical solutions provided in embodiments of this application, the following uses a three-level direct current converter as an example. FIG. 2 is a circuit diagram of a three-level direct current converter according to an embodiment of this application. As shown in FIG. 2, the three-level direct current converter includes a high-voltage power supply V_{H}, a capacitor C₁, a switching transistor Q₁, a switching transistor Q₂, a switching transistor Q₃, a switching transistor Q₄, a flying capacitor Cfly, an inductor L₁, a capacitor C₂, and a low-voltage power supply V_{L}.

The switching transistor Q₁, the switching transistor Q₂, the switching transistor Q₃, and the switching transistor Q₄ may be field effect transistors (FET), metal-oxide-semiconductor field effect transistors (MOSFET), insulated gate bipolar transistors (IGBT), junction field effect transistors (JFET), diodes connected in parallel to the junction field effect transistors, and the like. This is not limited herein.

A drain electrode of the switching transistor Q₁ is connected to a positive end of the high-voltage power supply V_{H} (a parallel capacitor C₁), and a source electrode of the switching transistor Q₁ is connected to a drain electrode of the switching transistor Q₂ and one end of the flying capacitor C_{fly}. The other end of the flying capacitor C_{fly} is connected to a source electrode of the switching transistor Q₃ and a drain electrode of the switching transistor Q₄. A source electrode of the switching transistor Q₂ and a drain electrode of the switching transistor Q₃ are connected to one end of the inductor L₁, and the other end of the inductor L₁ is connected to a negative end of the low-voltage power supply V_{L} (a parallel capacitor C₂).

In this embodiment of this application, the switching transistors may be grouped based on a connection relationship between the flying capacitor C_{fly} and the switching transistors, to obtain two switching transistor groups connected to the flying capacitor C_{fly}. For example, the switching transistor Q₁ and the switching transistor Q₄ are a switching transistor group, and the switching transistor Q₂ and the switching transistor Q₃ are a switching transistor group. Further, according to a connection relationship between the switching transistors and the high-voltage power supply V_{H} of the multi-level direct current converter, switching transistors that are in the switching transistor groups and that are connected to one end of the high-voltage power supply V_{H} are referred to as first switching transistors, and switching transistors that are in the switching transistor groups and that are connected to the other end of the high-voltage power supply V_{H} are referred to as second switching transistors. For example, if the first switching transistors are connected to the positive end of the high-voltage power supply V_{H}, the first switching transistors may be the switching transistor Q₁ and the switching transistor Q₂. If the second switching transistors are connected to a negative end of the high-voltage power supply V_{H}, the second switching transistors may be the switching transistor Q₄ and the switching transistor Q₃.

A first switching transistor and a second switching transistor in a switching transistor group which on and off states are complementary. For example, the switching transistor Q₁ and the switching transistor Q₄ which on and off states are complementary. In this case, when the switching transistor Q₁ is in the on state, the switching transistor Q₄ is in the off state. The switching transistor Q₁ is in the off state, and the switching transistor Q₄ is in the on state. In this way, a current signal may be transferred by using a carrier of a switching transistor that is turned on in the first switching transistor and the second switching transistor in the switching transistor group.

Because the first switching transistor and the second switching transistor in the same switching transistor group which on and off states are complementary, if the first switching transistor in the switching transistor group is turned off, the second switching transistor in the switching transistor group needs to be controlled to be turned on. If the first switching transistor in the switching transistor group is closed, the second switching transistor in the switching transistor group needs to be controlled to be turned off. The following describes a method for controlling a first switching transistor in a switching transistor group. For a method for controlling a second switching transistor in the switching transistor group, refer to the description of the method for controlling the first switching transistor for corresponding adjustment.

In this application, one flying capacitor is used as an example for description. Actually, there may be two or more flying capacitors, for example, another flying capacitor that is not shown in FIG. 2 and that is connected in series to a flying capacitor C_{fly}. Alternatively, two flying capacitors may be stored in a five-level direct current converter, and one flying capacitor is connected in parallel to a first switching transistor group and a second switching transistor group. In the five-level direct current converter, the second switching transistor group includes a first sub-switch group and a second sub-switch group, and the first sub-switch group and the second sub-switch group are connected in parallel to the other flying capacitor. This application does not limit a magnitude and quantity of an inductor, and the multi-level direct-current converter may further include a capacitor, a resistor, and the like connected to the inductor.

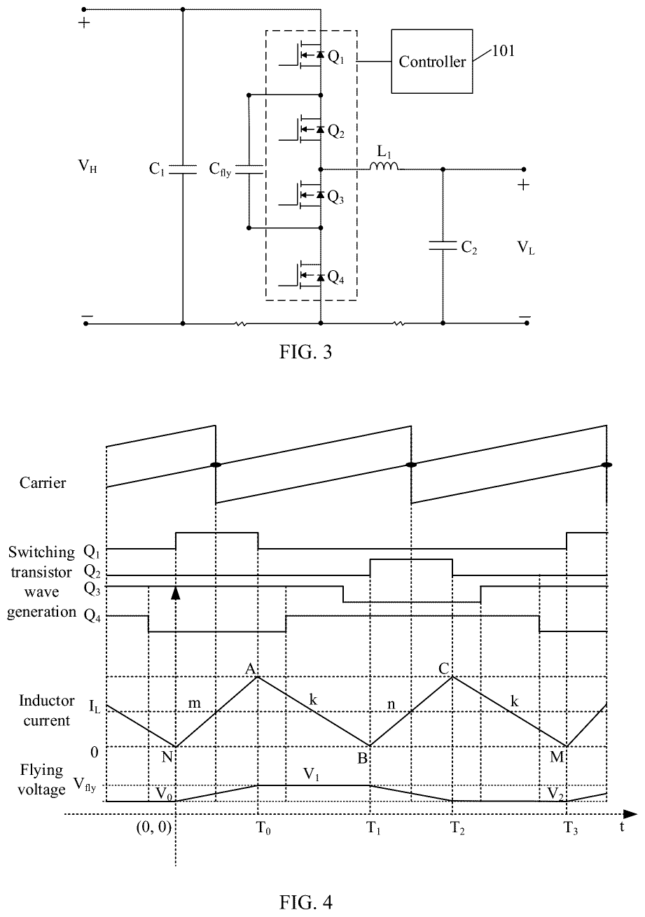

The three-level direct current converter may further include a controller 101 configured to control the switching transistor group in FIG. 3. The controller 101 may be a pulse width modulation (PWM) device, a PWM technology-based battery management system (BMS), a micro control unit (MCU), a central processing unit (CPU), another general purpose processor, a digital signal processor (DSP), an application specific integrated circuit (ASIC), a field-programmable gate array (FPGA) or another programmable logic device, a discrete gate or transistor logic device, a discrete hardware component, or the like. The controller may be understood as one chip or a plurality of chips that have a communication connection. The controller may include a control unit corresponding to each switching transistor, or may include a control unit corresponding to a switching transistor group, for example, a pulse width modulator corresponding to the switching transistor Q₁ and the switching transistor Q₄, or a pulse width modulator corresponding to the switching transistor Q₂ and the switching transistor Q₃. This is not limited herein.

Carriers of the switching transistor Q₁, the switching transistor Q₂, the switching transistor Q₃, and the switching transistor Q₄ may be modulated by using the PWM technology, and an on state and an off state of the switching transistors are controlled, to implement real-time bidirectional power flow. When load is connected to the low-voltage power supply V_{L} of the three-level direct current converter, an input end of the three-level direct current converter is the high-voltage power supply V_{H}, an output end of the three-level direct current converter is the low-voltage power supply V_{L}, and a current of the three-level direct current converter flows from the high-voltage power supply V_{H} to the low-voltage power supply V_{L}. When the load is connected to the high-voltage power supply V_{H} of the three-level direct current converter, an input end of the three-level direct current converter is the low-voltage power supply V_{L}, an output end of the three-level direct current converter is the high-voltage power supply V_{H}, and a current of the three-level direct current converter flows from the low-voltage power supply V_{L} to the high-voltage power supply V_{H}.

In addition, charging and discharging time of the flying capacitor may be adjusted by determining a current direction of the inductor L₁, to control a voltage of the flying capacitor. For example, when the switching transistor Q₁ and the switching transistor Q₃ are turned on, the high-voltage power supply V_{H} acts on the low-voltage power supply V_{L} by using the switching transistor Q₁, the switching transistor Q₃, and the inductor L₁. If a current of the inductor L₁ flows from the high-voltage power supply V_{H} to the low-voltage power supply V_{L} (the current direction is positive), the flying capacitor C_{fly} is charged, and the voltage increases. If a current of the inductor L₁ flows from the low-voltage power supply V_{L} to a high-voltage power supply V_{H} (the current direction is negative), the flying capacitor C_{fly} is discharged, and the voltage decreases. When the switching transistor Q₂ and the switching transistor Q₄ are turned on, the flying capacitor C_{fly} acts on the low-voltage power supply V_{L} by using the switching transistor Q₂, the switching transistor Q₄, and the inductor L₁. If the current direction of the inductor L₁ is positive, the flying capacitor C_{fly} is discharged, and the voltage decreases. If the current direction of the inductor L₁ is negative, the flying capacitor C_{fly} is charged, and the voltage increases.

In this embodiment of this application, the voltage of the flying capacitor C_{fly} may be referred to as a flying voltage for short, and a current of the inductor may be referred to as an inductor current for short. If the inductor current is small, and the inductor current is a high-frequency triangular wave and repeatedly switched between positive and negative, this case may be referred to as light load. On the contrary, if the inductor current is large, and the inductor current is always positive or negative, this case may be referred to as heavy load. A difference between duty cycles may be referred to as a duty cycle difference for short, and a phase shift or a difference between phases may be referred to as a phase difference for short. A phase shift control method is to adjust the phase on the premise of a fixed duty cycle. A duty cycle adjustment method is to adjust the duty cycle on the premise of a fixed phase. In this way, a unity of adjustment can be improved, and an affected voltage can be smoothly changed.

When the three-level direct current converter operates in a steady state, duty cycles of the switching transistor Q₁ (the switching transistor Q₃) and the switching transistor Q₂ (the switching transistor Q₄) are equal, and a phase shift is 180°. In other words, a phase difference between carriers of the switching transistor Q₁ and the switching transistor Q₂ is 180°. Therefore, steady-state operation of the three-level direct current converter may be implemented by adjusting a difference (which may be referred to as a duty cycle difference for short) between duty cycles of the switching transistor Q₁ and the switching transistor Q₂. For example, when power flows from the high-voltage power supply V_{H} to the low-voltage power supply V_{L} (a current flows from the high-voltage power supply V_{H} to the low-voltage power supply V_{L}), the flying voltage may be increased by increasing a duty cycle of the switching transistor Q₁ and decreasing a duty cycle of the switching transistor Q₂, that is, by increasing a duty cycle difference between the switching transistor Q₁ and the switching transistor Q₂, and on the contrary, the flying voltage may be decreased by decreasing a duty cycle of the switching transistor Q₁ and increasing a duty cycle of the switching transistor Q₂, that is, by decreasing a duty cycle difference between the switching transistor Q₁ and the switching transistor Q₂. When power flows from the low-voltage power supply V_{L} to the high-voltage power supply V_{H} (a current flows from the low-voltage power supply V_{L} to the high-voltage power supply V_{H}), the flying voltage may be increased by decreasing a duty cycle of the switching transistor Q₁ and increasing a duty cycle of the switching transistor Q₂, that is, by decreasing a duty cycle difference between the switching transistor Q₁ and the switching transistor Q₂, and on the contrary, the flying voltage may be decreased by increasing a duty cycle of the switching transistor Q₁ and decreasing a duty cycle of the switching transistor Q₂, that is, by increasing a duty cycle difference between the switching transistor Q₁ and the switching transistor Q₂.

However, in a case of light load, controlling the voltage of the flying capacitor based on an instantaneous current direction has an extremely high requirement on a control chip, and is not applicable to an actual project. Even if a difference between duty cycles of first switching transistors (for example, the switching transistor Q₁ and the switching transistor Q₂) or second switching transistors (for example, the switching transistor Q₃ and the switching transistor Q₄) in the switching transistor groups connected in parallel to the flying capacitor is adjusted to a large value, the voltage of the flying capacitor cannot be effectively increased or decreased, and a control objective of stabilizing the voltage of the flying capacitor at a target value cannot be achieved.

Based on this, this application proposes a multi-level direct current converter. A controller in the multi-level direct current converter is configured to: when an absolute value of a difference between a sampling voltage and a reference voltage of a flying capacitor is greater than a first threshold, adjust, based on a magnitude of the inductor current, a duty cycle difference between first switching transistors in the two switching transistor groups or a phase difference between carriers of first switching transistors in the two switching transistor groups.

The sampling voltage of the flying capacitor is a collected real-time voltage. The reference voltage of the flying capacitor is a target value to be adjusted for the flying capacitor. For example, the target value of the three-level direct current converter may be ½ times a voltage of a high-voltage power supply. A current of an inductor is also referred to as the inductor current, and may be an instantaneous current value or an average value. The first threshold is not limited in this application. The first threshold may be 0, or the like. It may be understood that, if the absolute value of the difference between the sampling voltage and the reference voltage of the flying capacitor is greater than the first threshold, it indicates that the voltage of the flying capacitor is not adjusted to the target value, and a duty cycle difference between switching transistors connected in parallel to a side of the flying capacitor or a phase difference between carriers of first switching transistors on the side may continue to be adjusted, to control a voltage of the flying capacitor and reduce a voltage stress of the multi-level direct current converter. If the difference between the sampling voltage and the reference voltage of the flying capacitor is less than or equal to the first threshold, it indicates that the voltage of the flying capacitor has been adjusted to the target value, and a current operating state may be maintained and the flying capacitor continues to operate. In this way, operation stability of the multi-level direct current converter can be improved.

A method for adjusting the phase difference and the duty cycle difference is not limited in this application. The switching transistor Q₁ and the switching transistor Q₂ are used as an example. After the duty cycle difference is determined to be adjusted, adjustment may be performed based on the foregoing adjustment method based on a current direction. For example, when a current flows from a high-voltage power supply to a low-voltage power supply, if the sampling voltage of the flying capacitor C_{fly} is less than the reference voltage of the flying capacitor C_{fly}, a duty cycle difference between first switching transistors in the two switching transistor groups may be increased. In other words, a duty cycle of the switching transistor Q₁ is increased, and a duty cycle of the switching transistor Q₂ is decreased, to increase a flying voltage. Alternatively, when a current flows from a high-voltage power supply to a low-voltage power supply, if the sampling voltage of the flying capacitor C_{fly} is greater than the reference voltage of the flying capacitor C_{fly}, a duty cycle difference between first switching transistors in the two switching transistor groups may be decreased. In other words, a duty cycle of the switching transistor Q₁ is decreased, and a duty cycle of the switching transistor Q₂ is increased, to decrease a flying voltage. Alternatively, when a current flows from a low-voltage power supply to a high-voltage power supply, if the sampling voltage of the flying capacitor C_{fly} is less than the reference voltage of the flying capacitor C_{fly}, a duty cycle difference between first switching transistors in the two switching transistor groups may be decreased. In other words, a duty cycle of the switching transistor Q₁ is decreased, and a duty cycle of the switching transistor Q₂ is increased, to increase a flying voltage. Alternatively, when a current flows from a low-voltage power supply to a high-voltage power supply, if the sampling voltage of the flying capacitor C_{fly} is greater than the reference voltage of the flying capacitor C_{fly}, a duty cycle difference between first switching transistors in the two switching transistor groups may be increased. In other words, a duty cycle of the switching transistor Q₁ is increased, and a duty cycle of the switching transistor Q₂ is decreased, to decrease a flying voltage. In this way, when it is decided to adjust the duty cycle difference, the voltage of the flying capacitor C_{fly} is adjusted based on a direction of the inductor current.

A principle of adjusting the phase difference of the flying capacitor C_{fly} is: increasing the phase difference between the carriers of the first switching transistors (or the second switching transistors), so that charging time (area) of the flying capacitor C_{fly} is greater than discharging time (area) of the flying capacitor C_{fly}, to increase the voltage of the flying capacitor C_{fly}; or reducing the phase difference between the carriers of the first switching transistors (or the second switching transistors), so that charging time (area) of the flying capacitor C_{fly} is less than discharging time (area) of the flying capacitor C_{fly}, to decrease the voltage of the flying capacitor C_{fly}. Therefore, in a possible example, when the phase difference between the carriers of the first switching transistors in the two switching transistor groups is determined to be adjusted based on the magnitude of the inductor current, and the sampling voltage of the flying capacitor C_{fly} is less than the reference voltage of the flying capacitor C_{fly}, the phase difference between the carriers of the first switching transistors in the two switching transistor groups is increased. Alternatively, when the phase difference between the carriers of the first switching transistors in the two switching transistor groups is determined to be adjusted based on the magnitude of the inductor current, and the sampling voltage of the flying capacitor C_{fly} is greater than the reference voltage of the flying capacitor C_{fly}, the phase difference between the carriers of the first switching transistors in the two switching transistor groups is decreased.

In this application, whether a manner of adjusting the phase difference or a manner of adjusting the duty cycle difference is used is not limited. An operating condition state of the multi-level direct current converter may be first analyzed. FIG. 4 to FIG. 9 are operating mode diagrams of a three-level direct current converter according to this application. V₀ is a flying voltage V_{fly} at the beginning of a cycle; V₁ is a flying voltage V_{fly} at any time in a cycle; V2 is a flying voltage V_{fly} at the end of a cycle; I_{L} is an inductor current, which is alternatively described by using i(t) in the following formula; N/A/B/C/M is a peak value of the inductor current I_{L}; T₀ to T₃ are time points of different phases in a switch cycle. It is considered that a deadband d may cause different freewheeling loops in different modes, values of T₀ to T₃ vary; and m/k/n is a slope of a corresponding straight line in the figure.

In the following, P is a switch cycle, D₁ is a duty cycle of a switching transistor Q₁, and D₂ is a duty cycle of a switching transistor Q₂. A duty cycle D of the three-level direct current converter may be understood as a steady-state duty cycle of a converter in an ideal case. In the ideal case, the duty cycle D of the three-level direct current converter is equal to the duty cycle D₁ of the switching transistor Q₁, and is equal to the duty cycle D₂ of the switching transistor Q₂. Actually, because the flying voltage deviates from a target value, a duty cycle difference between the switching transistor Q₁ and the switching transistor Q₂ or a phase difference between carriers of the switching transistor Q₁ and the switching transistor Q₂ needs to be adjusted. If the duty cycle D is less than 0.5, it indicates that both the duty cycle D₁ of the switching transistor Q₁ and the duty cycle D₂ of the switching transistor Q₂ are less than 0.5. If the duty cycle D is greater than 0.5, it indicates that both the duty cycle D₁ of the switching transistor Q₁ and the duty cycle D₂ of the switching transistor Q₂ are greater than 0.5. FIG. 4 to FIG. 9 respectively correspond to a mode 1, a mode 2, a mode 3, a mode 4, a mode 5, and a mode 6.

Mode 1: The duty cycle D is less than 0.5, and the inductor current I_{L} is always positive, that is, a case of heavy load. Referring to FIG. 4, T₀=D₁P,

$${T}_{1} = \frac{P}{2} , {T}_{2} = \frac{P}{2} + {D}_{2} ,$$

### and T₃=P.

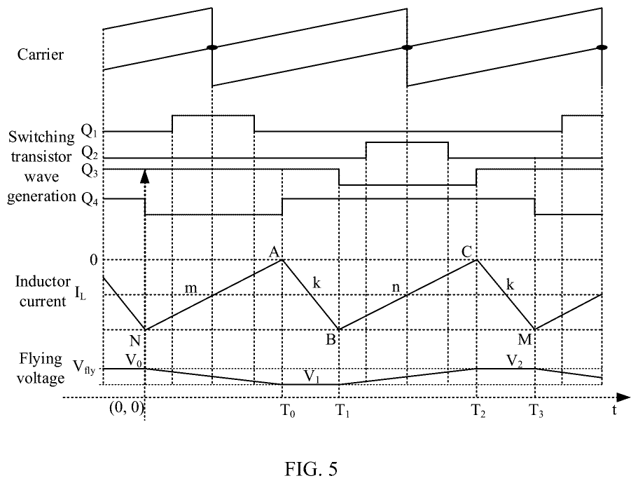

Mode 2: The duty cycle D is less than 0.5, and the inductor current I_{L} is always negative, that is, a case of heavy load. Referring to FIG. 5, T₀=(D₁+2d)P,

$${T}_{1} = \frac{P}{2} , {T}_{2} = \frac{P}{2} + ( {D}_{2} + 2 d ) P ,$$

### and T₃=P.

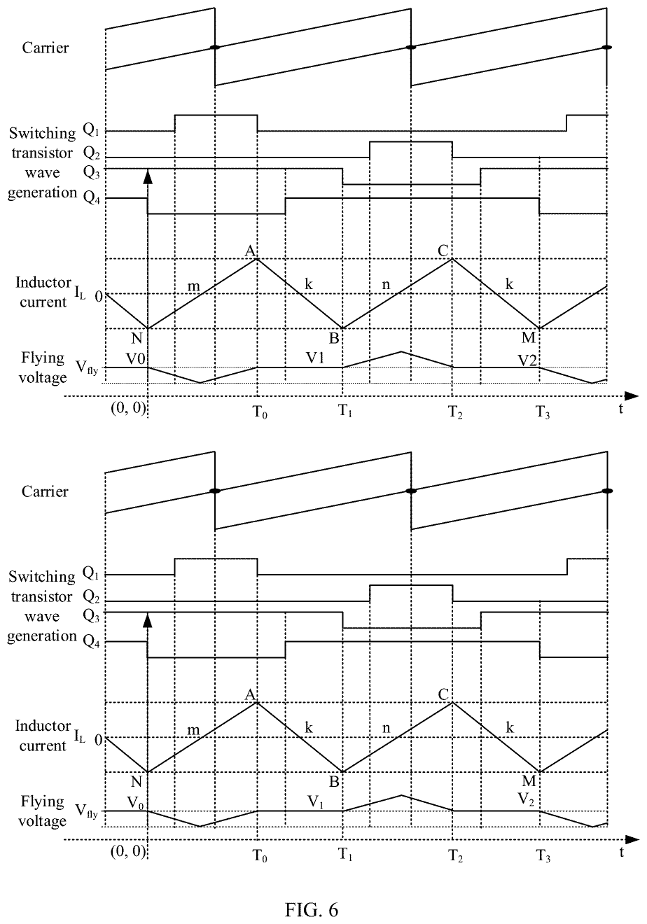

Mode 3: The duty cycle D is less than 0.5, and the inductor current I_{L} (t) may be negative or positive, that is, a case of light load. Referring to FIG. 6, T₀=(D₁+d)P,

$${T}_{1} = \frac{P}{2} , {T}_{2} = \frac{P}{2} + ( {D}_{2} + d ) P ,$$

### and T₃=P.

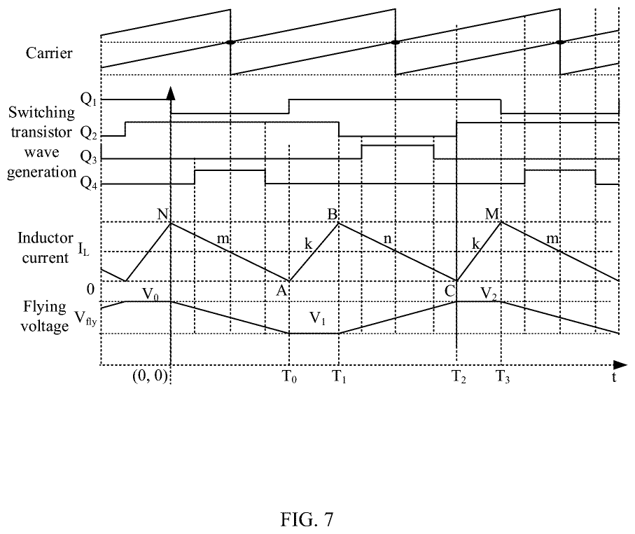

Mode 4: The duty cycle D is greater than 0.5, and the inductor current I_{L} is always positive, that is, a case of heavy load. Referring to FIGS. 7, T₀=(1−D₁)P,

$${T}_{1} = \frac{P}{2} , {T}_{2} = \frac{P}{2} + ( 1 - {D}_{2} ) P ,$$

### and T₃=P.

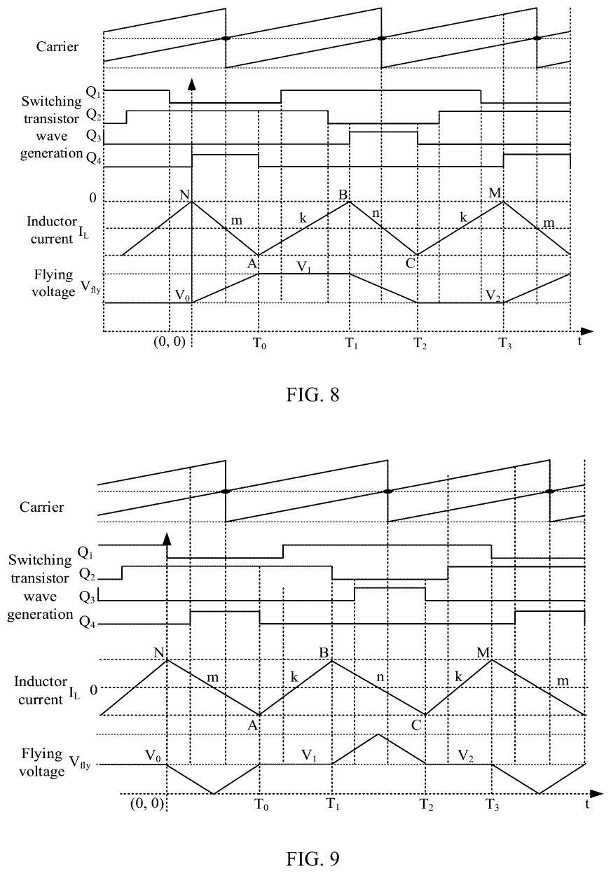

Mode 5: The duty cycle D is greater than 0.5, and the inductor current I_{L} is always negative, that is, a case of light load. Referring to FIGS. 8, T₀=[1−(D₁+2d)]P,

$${T}_{1} = \frac{P}{2} , {T}_{2} = \frac{P}{2} + [ 1 - ( {D}_{2} + 2 d ) ] P ,$$

### and T₃=P.

Mode 6: The duty cycle D is greater than 0.5, and the inductor current I_{L} may be negative or positive, that is, a case of light load. Referring to FIGS. 9, T₀=[1−(D₁+d)]P,

$${T}_{1} = \frac{P}{2} , {T}_{2} = \frac{P}{2} + [ 1 - ( {D}_{2} + d ) ] P ,$$

### and T₃=P.

By properly establishing a coordinate system and based on the freewheeling loop of the inductor current in FIG. 4 to FIG. 6, in the mode 1, the mode 2, and the mode 3, the deadband d may be combined into the duty cycle D₁ and the duty cycle D₂ for unified analysis. Based on the freewheeling loop of the inductor current in FIG. 7 to FIG. 9, in the mode 4, the mode 5, and the mode 6, the deadband d may be combined into the duty cycle D₁ and the duty cycle D₂ for unified analysis. The following uses the mode 1 and the mode 4 as an example.

In a switch cycle, a voltage variation of the flying capacitor may be obtained by performing integration on a current flowing through the flying capacitor, for example, formula (1).

$$Δ {V}_{fly} = {V}_{2} - {V}_{1} = \{ \begin{matrix}- \frac{1}{{C}_{fly}} ( {\int }_{{T}_{1}}^{{T}_{2}} i ( t ) dt - {\int }_{0}^{{T}_{0}} i ( t ) dt ) , D < 0.5 \\ \frac{1}{{C}_{fly}} ( {\int }_{{T}_{1}}^{{T}_{2}} i ( t ) dt - {\int }_{0}^{{T}_{0}} i ( t ) dt ) , D > 0.5\end{matrix} \qquad Formula ( 1 )$$

Formula (2) is obtained by calculating a common part in formula (1).

$${\int }_{{T}_{1}}^{{T}_{2}} i ( t ) dt - {\int }_{0}^{{T}_{0}} i ( t ) dt = \frac{1}{2} {nt}^{2} \vert \begin{matrix}{T}_{2} \\ {T}_{1}\end{matrix} + ( - {T}_{0} k + {T}_{1} k + {mT}_{0} - {nT}_{1} ) ( {T}_{2} - {T}_{1} ) - \frac{1}{2} {nt}^{2} \vert \begin{matrix}{T}_{2} \\ {T}_{1}\end{matrix} - {NT}_{0} \qquad Formula ( 2 )$$

For values of m, n, and k, refer to the following formula, and L in the formula is a magnitude of the inductor.

$$\{ \begin{matrix}D < 0.5 : m = \frac{{v}_{in} - {v}_{fly} - {v}_{out}}{L} , n = \frac{{v}_{fly} - {v}_{out}}{L} , k = \frac{- {v}_{out}}{L} \\ D > 0.5 : m = \frac{{v}_{fly} - {v}_{out}}{L} , n = \frac{{v}_{in} - {v}_{fly} - {v}_{out}}{L} , k = \frac{{v}_{in} - {v}_{out}}{L}\end{matrix}$$

If a phase difference between carriers of the switching transistor Q₁ (or a switching transistor Q₃) and the switching transistor Q₂ (or the switching transistor Q₄) is fixed to 180°, impact of different duty cycle differences on the flying voltage may be obtained by adjusting the duty cycle D₁ and the duty cycle D₂. For example, when D<0.5, the time T₀ to the time T₃ in the mode 1 are substituted into formula (2) to obtain formula (3).

$${C}_{fly} {ΔV}_{fly} = - \{ \frac{{P}^{2}}{P} [ {nD}_{2}^{2} - {mD}_{1}^{2} + 2 ( m - k ) {D}_{1} {D}_{2} + {kD}_{2} + N ( {D}_{2} - {D}_{1} ) P ] \} \qquad Formula ( 3 )$$

When D>0.5, the time T₀ to the time T₃ in the mode 4 are substituted into formula (2) to obtain formula (4).

$${C}_{fly} {ΔV}_{fly} = \frac{{P}^{2}}{2} [ {n ( 1 - {D}_{2} )}^{2} - {m ( 1 - {D}_{1} )}^{2} + 2 ( m - k ) ( 1 - {D}_{1} ) ( 1 - {D}_{2} ) + k ( 1 - {D}_{2} ) ] + N [ ( 1 - {D}_{2} ) - ( 1 - {D}_{1} ) ] P \qquad Formula ( 4 )$$

If a duty cycle of the duty cycle D1 and the duty cycle D2 is fixed to D (which may be any fixed value in 0 to 1), and the phase difference between the carriers of the switching transistor Q₁ (or the switching transistor Q₄) and the switching transistor Q₂ (or the switching transistor Q₃) is adjusted to Δθ, impact of different phase differences on the flying voltage may be obtained, that is, impact of phase shift control on the flying voltage. When D<0.5, the time T₀ to the time T₃ in the mode 1 are substituted into formula (2) to obtain formula (5).

$${C}_{fly} {ΔV}_{fly} = D Δθ \frac{{v}_{out}}{L} {P}^{2} \qquad Formula ( 5 )$$

When D>0.5, the time T₀ to the time T₃ in the mode 4 are substituted into formula (2) to obtain formula (6).

$${C}_{fly} {ΔV}_{fly} = ( 1 - D ) Δθ \frac{{v}_{bus} - {v}_{out}}{L} {P}^{2} \qquad Formula ( 6 )$$

According to formula (5) and formula (6), under phase shift control, the flying voltage has a consistent adjustment direction under light and heavy load and positive and negative power flow directions. In other words, the flying voltage increases when the phase difference increases, or the flying voltage decreases when the phase difference decreases. This relationship is not related to the deadband.

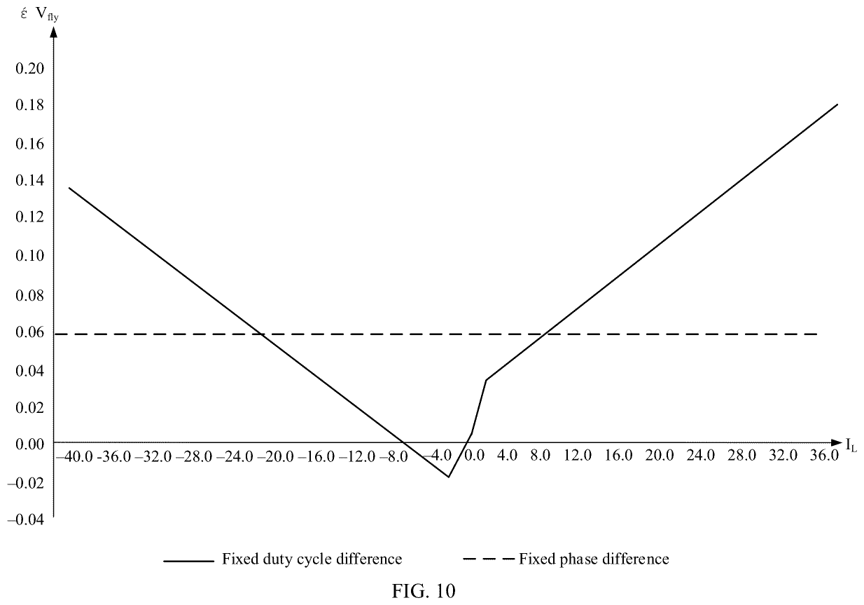

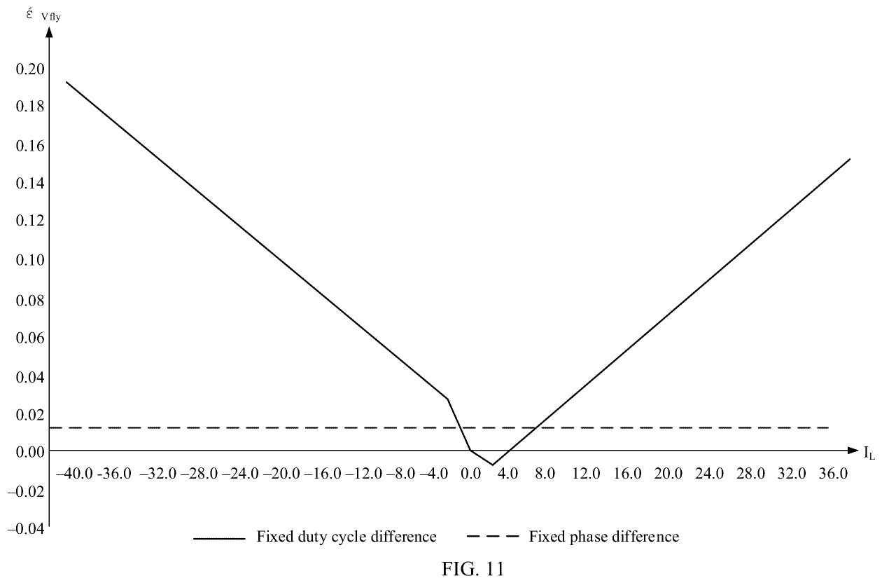

Then, refer to FIG. 10 to FIG. 13. FIG. 10 to FIG. 13 are respectively diagrams of relationships between a duty cycle difference and a flying voltage and a flying voltage and a phase difference and a flying voltage according to this application. FIG. 10 and FIG. 11 are used to describe, in a case of a fixed phase difference and a fixed duty cycle difference, impact on a change of the flying voltage based on different load. A horizontal axis is an inductor current I_{L}, and a vertical axis is a change amount ΔV_{fly} of the flying voltage. A solid line corresponding to the fixed duty cycle difference reflects an adjustment strength of the voltage of the flying capacitor under different load when a same duty cycle difference is adjusted for the first switching transistor. A dashed line corresponding to the fixed phase difference reflects an adjustment strength of the voltage of the flying capacitor under different load when a same phase difference is adjusted for the first switching transistor. FIG. 10 uses an application scenario in which formula (3) and formula (5) are used, D<0.5, and D=0.34 as an example. FIG. 11 uses an application scenario in which formula (4) and formula (6) are used, D>0.5, and D=0.8 as an example. It can be seen from FIG. 10 and FIG. 11 that under light load (the inductor current may be a high-frequency triangular wave, repeatedly switched between positive and negative, a value is relatively small, and may be a part in which the dashed line is greater than the solid line and is close to a value 0 in the figure), a change value of the flying voltage is small. Moreover, adjusting the duty cycle will cause the flying voltage to change reversely. As the load increases gradually, the change value of the flying voltage gradually increases, so that the flying voltage can be controlled by adjusting the duty cycle under heavy load. In other words, the method for adjusting the duty cycle quickly reduces a control strength of the flying voltage as the load gradually decreases. In contrast, a control strength of the phase shift control is strong under the light load, and weak under the heavy load, so that the phase shift can be controlled under the light load. In other words, the phase difference is adjusted to control the flying voltage.

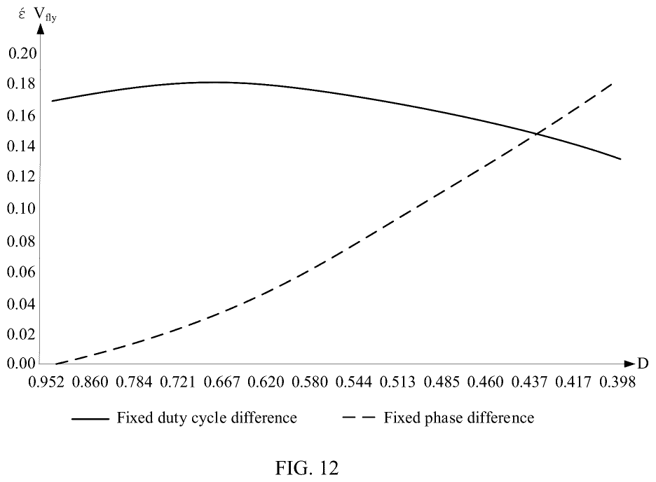

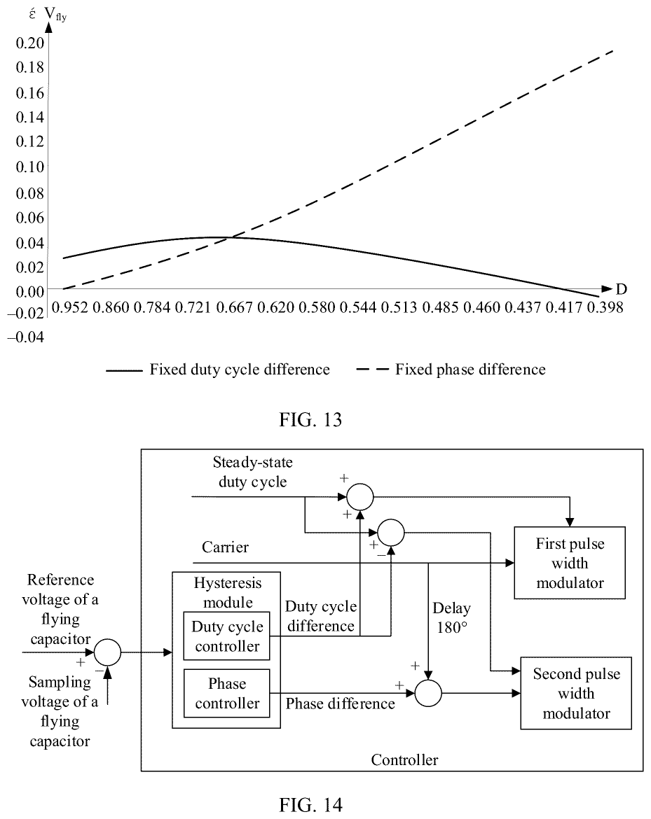

FIG. 12 and FIG. 13 are used to describe impact of the fixed duty cycle difference and the fixed phase difference on a change of the flying voltage under fixed load. A horizontal axis is the duty cycle D, and a vertical axis is a change amount ΔV_{fly} of the flying voltage. FIG. 12 is applied to the heavy load, and FIG. 13 is applied to the light load. It can be seen from FIG. 12 and FIG. 13 that, in a phase shift control method, as the duty cycle gradually increases, a control strength of the flying voltage quickly decreases. However, under the light load, the phase shift control method can maintain a larger adjustment strength than the duty cycle adjustment method. In this way, under the light load, the flying voltage may be controlled by using the phase shift control method. Under the heavy load, the flying voltage can be controlled by adjusting the duty cycle.

Based on this, in a possible example, a controller is specifically configured to adjust a phase difference between carriers of first switching transistors in two switching transistor groups in response to that an inductor current is less than a second threshold. Alternatively, the controller is specifically configured to adjust a duty cycle difference between the first switching transistors in the two switching transistor groups in response to that the inductor current is greater than a third threshold. Alternatively, the controller is specifically configured to: in response to that the inductor current is greater than or equal to a second threshold and less than or equal to a third threshold, adjust, according to an adjustment method at a previous moment, the duty cycle difference between the first switching transistors in the two switching transistor groups or the phase difference between the carriers of the first switching transistors in the two switching transistor groups.

Values of the second threshold and the third threshold are not limited in this application, and the second threshold is less than the third threshold. It may be understood that, if the current of the inductor is less than the second threshold, it indicates that the current of the inductor is small, and the current may be a case of light load. On the premise that the duty cycle difference is not adjusted, the phase difference between the carriers of the first switching transistors in the two switching transistor groups may be adjusted by using a phase shift control method. If the current of the inductor is greater than the third threshold, it indicates that the current of the inductor is large, and the current may be a heavy load case. On the premise that the phase difference is not adjusted, the duty cycle difference between the first switching transistors in the two switching transistor groups may be adjusted by using a duty cycle adjustment method. If the current of the inductor is greater than or equal to the second threshold and less than or equal to the third threshold, the inductor may be in an intermediate state of light load and heavy load, and the adjustment may be performed in an adjustment manner at a previous moment. For example, if the phase shift control method is used at the previous moment, the phase shift control method is still used; or if the duty cycle adjustment method is used at the previous moment, the duty cycle adjustment method is still used. In this way, the flying voltage may be controlled by using the foregoing three cases, so that the voltage of the controlled flying capacitor keeps smooth transition.

In a possible example, the controller may include a hysteresis module, and a first pulse width modulator and a second pulse width modulator that are connected to the hysteresis module. The first pulse width modulator is configured to adjust a phase or a duty cycle of a first switching transistor (or a second switching transistor) in a switching transistor group connected to the flying capacitor, and the second pulse width modulator is configured to adjust a phase or a duty cycle of a first switching transistor (or a second switching transistor) in another switching transistor group connected to the flying capacitor. For example, the first pulse width modulator is configured to adjust a phase or a duty cycle of the switching transistor Q₁ or the switching transistor Q₄, and the second pulse width modulator is configured to adjust a phase or a duty cycle of the switching transistor Q₂ or the switching transistor Q₃. The hysteresis module may include a duty cycle controller and a phase controller. The duty cycle controller is configured to control the first pulse width modulator and the second pulse width modulator to execute a duty cycle control loop, to adjust a duty cycle difference between two switching transistors. The phase controller is configured to control the first pulse width modulator and the second pulse width modulator to execute a phase control loop, to adjust a phase difference between carriers of two switching transistors.

The hysteresis module is configured to: in response to that the absolute value of the difference between the sampling voltage and the reference voltage of the flying capacitor is greater than the first threshold, control, based on the magnitude of the inductor current, the first pulse width modulator and the second pulse width modulator to adjust the phase difference between carriers of first switching transistors in the two switching transistor groups or the duty cycle difference between first switching transistors in the two switching transistor groups.

The hysteresis module is specifically configured to: when hysteresis module determines to adjust the phase difference between the carriers of the first switching transistors in the two switching transistor groups based on a magnitude of the inductor current, increase the phase difference between the carriers of the first switching transistors in the two switching transistor groups if the sampling voltage of the flying capacitor is less than the reference voltage of the flying capacitor. Alternatively, if the sampling voltage of the flying capacitor is greater than the reference voltage of the flying capacitor, the phase difference between the carriers of the first switching transistors in the two switching transistor groups is decreased.

The hysteresis module is specifically configured to: when the hysteresis module determines to adjust the duty cycle difference between the first switching transistors in the two switching transistor groups based on the magnitude of the inductor current, increase the duty cycle difference between the first switching transistors in the two switching transistor groups if a current flows from a high-voltage power supply to a low-voltage power supply, and the sampling voltage of the flying capacitor is less than the reference voltage of the flying capacitor; or decrease the duty cycle difference between the first switching transistors in the two switching transistor groups if a current flows from a high-voltage power supply to a low-voltage power supply, and the sampling voltage of the flying capacitor is greater than the reference voltage of the flying capacitor; or decrease the duty cycle difference between the first switching transistors in the two switching transistor groups if a current flows from a low-voltage power supply to a high-voltage power supply, and the sampling voltage of the flying capacitor is less than the reference voltage of the flying capacitor; or increase the duty cycle difference between the first switching transistors in the two switching transistor groups if a current flows from a low-voltage power supply to a high-voltage power supply, and the sampling voltage of the flying capacitor is greater than the reference voltage of the flying capacitor.

The hysteresis module is specifically configured to: in response to that the current is less than the second threshold, control the first pulse width modulator and the second pulse width modulator to adjust the phase difference between the carriers of the first switching transistors in the two switching transistor groups; or in response to that the current is greater than the third threshold, control the first pulse width modulator and the second pulse width modulator to adjust the duty cycle difference between the first switching transistors in the two switching transistor groups; or in response to that the current is greater than or equal to the second threshold and less than or equal to the third threshold, control the first pulse width modulator and the second pulse width modulator according to the adjustment method at a previous moment, to adjust the phase difference between the carriers of the first switching transistors in the two switching transistor groups or the duty cycle difference between the first switching transistors in the two switching transistor groups.

An example in which the first switching transistors are the switching transistor Q₁ and the switching transistor Q₂ is used for description. FIG. 14 is a schematic flowchart of adjusting a voltage of a flying capacitor by a controller according to this application. As shown in FIG. 14, a hysteresis module may first determine whether an absolute value of a difference between a sampling voltage V_{fly_ad} of a flying capacitor and a reference voltage V_{fly_ref} of the flying capacitor is greater than a first threshold. If the difference between the sampling voltage V_{fly_ad} of the flying capacitor and the reference voltage V_{fly_ref} of the flying capacitor is greater than the first threshold, and an average value i_{LAVG} of an inductor current is less than a second threshold, a phase shift control loop corresponding to a phase controller may be controlled to operate on the premise that a duty cycle is controlled to remain unchanged (an output limiting linear change of a duty cycle control loop is zero), so that a first pulse width modulator applies a current output result of the duty cycle control loop to a steady-state duty cycle based on a direction of the inductor current. Then, a second pulse width modulator adds the output result of the phase shift control loop to a carrier of a switching transistor corresponding to the second pulse width modulator, so that a phase difference between carriers of a switching transistor Q₁ corresponding to the first pulse width modulator and a switching transistor Q₂ corresponding to the second pulse width modulator is dynamically adjusted around 180°. When i_{LAVG} is greater than a third threshold, a duty cycle control loop corresponding to a duty cycle controller may be controlled to operate on the premise that the control phase difference remains unchanged, so that the first pulse width modulator and the second pulse width modulator apply, according to the direction of the inductor current, the current output result of the phase shift control loop to the carrier corresponding to the second pulse width modulator, so that the duty cycle difference between the switching transistor Q₁ and the switching transistor Q₂ is dynamically adjusted around 0. When i_{LAVG} is between the second threshold and the third threshold, keeping the adjustment manner at the previous moment to control the phase shift control loop corresponding to the phase controller to operate, so that the first pulse width modulator and the second pulse width modulator adjust the phase difference between the carriers of the switching transistor Q₁ and the switching transistor Q₂, or control the duty cycle control loop corresponding to the duty cycle controller to operate, so that the first pulse width modulator and the second pulse width modulator adjust the duty cycle difference between the switching transistor Q₁ and the switching transistor Q₂.

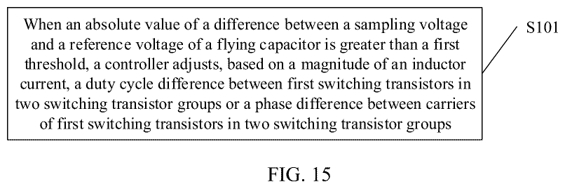

FIG. 15 is a schematic flowchart of a voltage control method for a flying capacitor according to an embodiment of this application. The flying capacitor may be used in a multi-level direct current converter shown in FIG. 3. The multi-level direct current converter includes at least one flying capacitor, two switching transistor groups connected to the flying capacitor, an inductor connected to each switching transistor group and a positive electrode of a low-voltage of the multi-level direct current converter, and a controller configured to control the switching transistor groups. Each switching transistor group includes a first switching transistor and a second switching transistor which on and off states are complementary. As shown in FIG. 15, the voltage control method may include step S101.

S101: When an absolute value of a difference between a sampling voltage and a reference voltage of a flying capacitor is greater than a first threshold, a controller adjusts, based on a magnitude of an inductor current, a duty cycle difference between first switching transistors in the two switching transistor groups or a phase difference between carriers of first switching transistors in the two switching transistor groups.

It may be understood that, if the absolute value of the difference between the sampling voltage and the reference voltage of the flying capacitor is greater than the first threshold, it indicates that a voltage of the flying capacitor is not adjusted to a target value, and a phase difference between switching transistors connected in parallel to a side of the flying capacitor or a duty cycle difference between switching transistors connected in parallel to the side may be further adjusted, to control the voltage of the flying capacitor. This improves operation stability of the multi-level direct current converter.

In a possible example, a method for adjusting, based on the magnitude of the inductor current, the duty cycle difference between the first switching transistors in the two switching transistor groups or the phase difference between the carriers of the first switching transistors in the two switching transistor groups may include the following step: when it is determined to adjust, based on the magnitude of the inductor current, the phase difference between the carriers of the first switching transistors in the two switching transistor groups, and the sampling voltage is less than the reference voltage of the flying capacitor, increasing the phase difference between the carriers of the first switching transistors in the two switching transistor groups; or when it is determined to adjust, based on the magnitude of the inductor current, the phase difference between the carriers of the first switching transistors in the two switching transistor groups, and the sampling voltage is greater than the reference voltage of the flying capacitor, decrease the phase difference between the carriers of the first switching transistors in the two switching transistor groups. In this way, the voltage of the flying capacitor is increased by increasing the phase difference between the carriers of the first switching transistors in the two switching transistor groups. The voltage of the flying capacitor is decreased by reducing the phase difference between the carriers of the first switching transistors in the two switching transistor groups.

In a possible example, a method for adjusting, based on the magnitude of the inductor current, the duty cycle difference between the first switching transistors in the two switching transistor groups or the phase difference between the carriers of the first switching transistors in two switching transistor groups may include the following step: when it is determined to adjust the duty cycle difference between the first switching transistors in the two switching transistor groups based on the magnitude of the inductor current, increasing the duty cycle difference between the first switching transistors in the two switching transistor groups if a current flows from a high-voltage power supply to a low-voltage power supply, and the sampling voltage of the flying capacitor is less than the reference voltage of the flying capacitor; or decreasing the duty cycle difference between the first switching transistors in the two switching transistor groups if a current flows from a high-voltage power supply to a low-voltage power supply, and the sampling voltage of the flying capacitor is greater than the reference voltage of the flying capacitor; or decreasing the duty cycle difference between the first switching transistors in the two switching transistor groups if a current flows from a low-voltage power supply to a high-voltage power supply, and the sampling voltage of the flying capacitor is less than the reference voltage of the flying capacitor; or increasing the duty cycle difference between the first switching transistors in the two switching transistor groups if a current flows from a low-voltage power supply to a high-voltage power supply, and the sampling voltage of the flying capacitor is greater than the reference voltage of the flying capacitor. In this way, when the duty cycle difference is determined to be adjusted, the voltage of the flying capacitor is adjusted based on the direction of the inductor current.

In a possible example, a method for adjusting, based on the magnitude of the inductor current, the duty cycle difference between the first switching transistors in two switching transistor groups or the phase difference between the carriers of the first switching transistors in the two switching transistor groups may include the following step: adjusting the phase difference between the carriers of the first switching transistors in the two switching transistor groups when the inductor current is less than a second threshold; or adjusting the duty cycle difference between the first switching transistors in the two switching transistor groups when the inductor current is greater than a third threshold; or when the inductor current is greater than or equal to a second threshold and less than or equal to a third threshold, adjusting, according to the adjustment method at the previous moment, the duty cycle difference between the first switching transistors in the two switching transistor groups or the phase difference between the carriers of the first switching transistors in the two switching transistor groups. In this way, the flying voltage may be controlled by using the foregoing three cases, so that the controlled voltage of the flying capacitor keeps smooth transition.

An embodiment of this application further provides a control apparatus. The control apparatus includes a controller and a memory. The memory is configured to store instructions, and the controller is configured to invoke the instructions stored in the memory to perform the method in any one of the foregoing aspects.

A person of ordinary skill in the art may understand that all or a part of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a removable storage device, a read-only memory (ROM), a random access memory (RAM), a magnetic disk, or an optical disc.

The foregoing descriptions are merely specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A multi-level direct current converter, comprising:
at least one flying capacitor,
two switching transistor groups, connected to the at least one flying capacitor,
an inductor, connected to each of the two switching transistor groups and a positive electrode end of a low-voltage power supply of the multi-level direct current converter,
a controller, configured to control the switching transistor groups,
wherein each of the two switching transistor groups comprises a first switching transistor and a second switching transistor which on and off states are complementary,
wherein the first switching transistor is connected to one end of a high-voltage power supply of the multi-level direct current converter, and the second switching transistor is connected to the other end of the high-voltage power supply of the multi-level direct current converter; and
wherein based on an absolute value of a difference between a sampling voltage and a reference voltage of the at least one flying capacitor being greater than a first threshold, the controller is further configured to: adjust, according to a magnitude of an inductor current, a duty cycle difference between first switching transistors in the two switching transistor groups or a phase difference between carriers of the first switching transistors in the two switching transistor groups.

2. The multi-level direct current converter according to claim 1, wherein the controller is further configured to:
increase the phase difference between the carriers of the first switching transistors in the two switching transistor groups based on the controller determining to adjust the phase difference between the carriers of the first switching transistors in the two switching transistor groups according to the magnitude of the inductor current, and wherein the sampling voltage of the at least one flying capacitor is less than the reference voltage of the at least one flying capacitor.

3. The multi-level direct current converter according to claim 1, wherein the controller is further configured to:
decrease the phase difference between the carriers of the first switching transistors in the two switching transistor groups based on the controller determining to adjust the phase difference between the carriers of the first switching transistors in the two switching transistor groups according to the magnitude of the inductor current, and wherein the sampling voltage of the at least one flying capacitor is greater than the reference voltage of the at least one flying capacitor.

4. The multi-level direct current converter according to claim 1, wherein the controller is further configured to:
adjust the phase difference between the carriers of the first switching transistors in the two switching transistor groups based on the inductor current being less than a second threshold.

5. The multi-level direct current converter according to claim 1, wherein the controller is further configured to:
adjust the duty cycle difference between the first switching transistors in the two switching transistor groups based on the inductor current being greater than a third threshold.

6. The multi-level direct current converter according to claim 1, wherein the controller is further configured to:
based on the inductor current being greater than or equal to a second threshold and less than or equal to a third threshold, adjust, according to an adjustment method at a previous moment, the duty cycle difference between the first switching transistors in the two switching transistor groups or the phase difference between the carriers of the first switching transistors in the two switching transistor groups.

7. A voltage control method for a flying capacitor, wherein the method is applied to a controller of a multi-level direct current converter which comprises the flying capacitor, the controller, two switching transistor groups, and an inductor, and the voltage control method comprises:
based on an absolute value of a difference between a sampling voltage and a reference voltage of the flying capacitor being greater than a first threshold, adjusting, by the controller according to a magnitude of an inductor current, a duty cycle difference between first switching transistors in the two switching transistor groups or a phase difference between carriers of the first switching transistors in the two switching transistor groups, wherein each of the two switching transistor groups comprises a first switching transistor and a second switching transistor which on and off states are complementary.

8. The voltage control method according to claim 7, wherein the adjusting the duty cycle difference or the phase difference comprises:
increasing, by the controller, the phase difference between the carriers of the first switching transistors in the two switching transistor groups based on the phase difference between the carriers of the first switching transistors in the two switching transistor groups being determined to be adjusted according to the magnitude of the inductor current, and wherein the sampling voltage of the flying capacitor is less than the reference voltage of the flying capacitor.

9. The voltage control method according to claim 7, wherein the adjusting the duty cycle difference or the phase difference comprises:
adjusting, by the controller, the phase difference between the carriers of the first switching transistors in the two switching transistor groups based on the inductor current being less than a second threshold; or
adjusting, by the controller, the duty cycle difference between the first switching transistors in the two switching transistor groups when the inductor current is greater than a third threshold; or
when the inductor current is greater than or equal to a second threshold and less than or equal to a third threshold, adjusting, by the controller according to an adjustment method at a previous moment, the duty cycle difference between the first switching transistors in the two switching transistor groups or the phase difference between the carriers of the first switching transistors in the two switching transistor groups.

10. A control apparatus, comprising:
a memory, configured to store instructions, and
a controller, configured to invoke the instructions stored in the memory, to perform a voltage control method for a flying capacitor which is used in a multi-level direct current converter comprising two switching transistor groups, an inductor, and the controller, and the voltage control method comprising:
based on an absolute value of a difference between a sampling voltage and a reference voltage of the flying capacitor being greater than a first threshold, adjusting, according to a magnitude of an inductor current, a duty cycle difference between first switching transistors in the two switching transistor groups or a phase difference between carriers of the first switching transistors in the two switching transistor groups, and wherein each of the two switching transistor groups comprises a first switching transistor and a second switching transistor which on and off states are complementary.

11. The control apparatus according to claim 10, wherein in adjusting the duty cycle difference or the phase difference, the controller is further configured to comprises:
increase, the phase difference between the carriers of the first switching transistors in the two switching transistor groups based on the phase difference between the carriers of the first switching transistors in the two switching transistor groups being determined to be adjusted according to the magnitude of the inductor current, and wherein the sampling voltage of the flying capacitor is less than the reference voltage of the flying capacitor.

12. The control apparatus according to claim 10, wherein in adjusting the duty cycle difference or the phase difference, the controller is further configured to:
adjust, the phase difference between the carriers of the first switching transistors in the two switching transistor groups based on the inductor current being less than a second threshold.

13. The voltage control method according to claim 7, wherein the adjusting the duty cycle difference or the phase difference comprises:
decreasing, by the controller, the phase difference between the carriers of the first switching transistors in the two switching transistor groups based on the phase difference between the carriers of the first switching transistors in the two switching transistor groups being determined to be adjusted according to the magnitude of the inductor current, and wherein the sampling voltage of the flying capacitor is greater than the reference voltage of the flying capacitor.

14. The voltage control method according to claim 7, wherein the adjusting the duty cycle difference or the phase difference comprises:
adjusting, by the controller, the duty cycle difference between the first switching transistors in the two switching transistor groups based on the inductor current being greater than a third threshold.

15. The voltage control method according to claim 7, wherein the adjusting the duty cycle difference or the phase difference comprises:
based on the inductor current being greater than or equal to a second threshold and less than or equal to a third threshold, adjusting, by the controller according to an adjustment method at a previous moment, the duty cycle difference between the first switching transistors in the two switching transistor groups or the phase difference between the carriers of the first switching transistors in the two switching transistor groups.

16. The control apparatus according to claim 10, wherein in adjusting the duty cycle difference or the phase difference, the controller is further configured to:
decrease, the phase difference between the carriers of the first switching transistors in the two switching transistor groups based on the phase difference between the carriers of the first switching transistors in the two switching transistor groups being determined to be adjusted according to the magnitude of the inductor current, and wherein the sampling voltage of the flying capacitor is greater than the reference voltage of the flying capacitor.

17. The control apparatus according to claim 10, wherein in adjusting the duty cycle or the phase difference, the controller is further configured to:
adjust, the duty cycle difference between the first switching transistors in the two switching transistor groups based on the inductor current being greater than a third threshold.

18. The control apparatus according to claim 10, wherein in adjusting the duty cycle difference or the phase difference, the controller is further configured to:
based on the inductor current being greater than or equal to a second threshold and less than or equal to a third threshold, adjust, according to an adjustment method at a previous moment, the duty cycle difference between the first switching transistors in the two switching transistor groups or the phase difference between the carriers of the first switching transistors in the two switching transistor groups.
